(19) United States
(12) Patent Application Publication
(10) Pub. No.: US 2008/0278517 A1
(43) Pub. Date: Nov. 13, 2008

(54) SYSTEM AND METHOD FOR MANIPULATION OF DOCUMENT DATA INTERCEPTED THROUGH PORT REDIRECTION

(76) Inventor: Arthur J. POIRIER, North Narrabeen (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/747,070

(22) Filed: May 10, 2007

(51) Int. Cl. G09G 5/00; G06F 15/00

(52) U.S. Cl. 345/629

(57) ABSTRACT

The subject application is directed to a system and method for manipulation of document data intercepted through port redirection. A virtual port receives targeted output data from each of a plurality of applications, which are associated with the virtual port. The output data is then stored in associated memory. Document images are then generated on an associated display corresponding to the stored output data. User instructions corresponding to the manipulation of the output data is then received via the associated display from the user. A single output job is then communicated to an associated document rendering device consisting of at least a portion of the stored output data.

### BACKGROUND OF THE INVENTION

The subject application is directed generally to rendering of electronically stored documents. The subject application is particularly useful in assembly and rendering of electronically stored documents intercepted from one or more virtual output ports associated with software applications.

There are many different applications, some of which may be embedded on dedicated devices, which are used in a typical office or document processing environment. Such applications include word processing, facsimile transmission, spread sheet generation, slide show generation, scanning, optical character recognition, computer aided design, or database usage. Typically, such applications include a mechanism to allow for generating an output, such as print out, electronic mail, plot, transparency rendering, and the like.

Frequently, a desirable, final document includes renderings that are taken from more than one source. For example, a spreadsheet may be included as an attachment, or one or more scanned items may be interleaved into other documents, such as word processing documents and database outputs. Since documents are obtained from a variety of sources, there is no seamless way to integrate resultant output.

Currently, a user will load each application, and generate an output of one or more copies of pertinent data. This process must be repeated for each application or system. Once tangible documents from each source have been received, the user must manually collate them and assemble them into a final form. This is a laborious process, and may result in lost pages or inaccurate ordering or assembly.

### SUMMARY OF THE INVENTION

In accordance with one embodiment of the subject application, there is provided a system and method for manipulation of document data intercepted through port redirection.

Further, in accordance with one embodiment of the subject application, there is provided a system and method for rendering of electronically stored documents.

Still further, in accordance with one embodiment of the subject application, there is provided a system and method for assembly and rendering of electronically stored documents intercepted from one or more virtual output ports associated with software applications.

Further, in accordance with one embodiment of the subject application, there is provided a system for manipulation of document data intercepted through port redirections wherein the system includes a virtual port associated with each of a plurality of applications and means adapted for receiving output data targeted to the virtual port from each of the plurality of applications. The system further includes memory means adapted for storing output data received in the virtual port and means adapted for generating a display representative of documents associated with stored output data. The system also comprises interface means adapted for receiving instructions relative to manipulation of stored output data in accordance with a generated display and means adapted for outputting, to at least one document rendering device, a single output job comprising at least a portion of stored output data.

In one embodiment of the subject application, the system further comprises spooler means adapted for spooling the output job prior to rendering.

In another embodiment of the subject application, the system further comprises at least one software driver associated with each of the plurality of applications. In such an embodiment, output data is received into the virtual port therefrom.

In yet another embodiment of the subject application, the document rendering device includes a multifunction peripheral, and wherein at least one software driver is directed to perform at least one operation chosen from the set of printing, facsimile transmission, and electronic mail transmission.

In a further embodiment of the subject application, the output data includes graphical image data. Preferably, the output data is further comprised of post-raster image processing graphical image data.

In another embodiment of the subject application, the interface means includes a graphical display generated on an associated thin client.

Still further, in accordance with one embodiment of the subject application, there is provided a method for manipulation of document data intercepted through port redirection in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for manipulation of document data intercepted through port redirection according to one embodiment of the subject application;

FIG. 2 is a block diagram illustrating controller hardware for use in the system for manipulation of document data intercepted through port redirection according to one embodiment of the subject application;

FIG. 3 is a functional diagram illustrating the controller for use in the system for manipulation of document data intercepted through port redirection according to one embodiment of the subject application;

FIG. 4 is a block diagram illustrating a workstation for use in the system for manipulation of document data intercepted through port redirection according to one embodiment of the subject application;

FIG. 5 is a flowchart illustrating a method for manipulation of document data intercepted through port redirection according to one embodiment of the subject application; and

FIG. 6 is a flowchart illustrating a method for manipulation of document data intercepted through port redirection according to one embodiment of the subject application.

### DETAILED DESCRIPTION OF THE PREFERRED EMBODIMENT

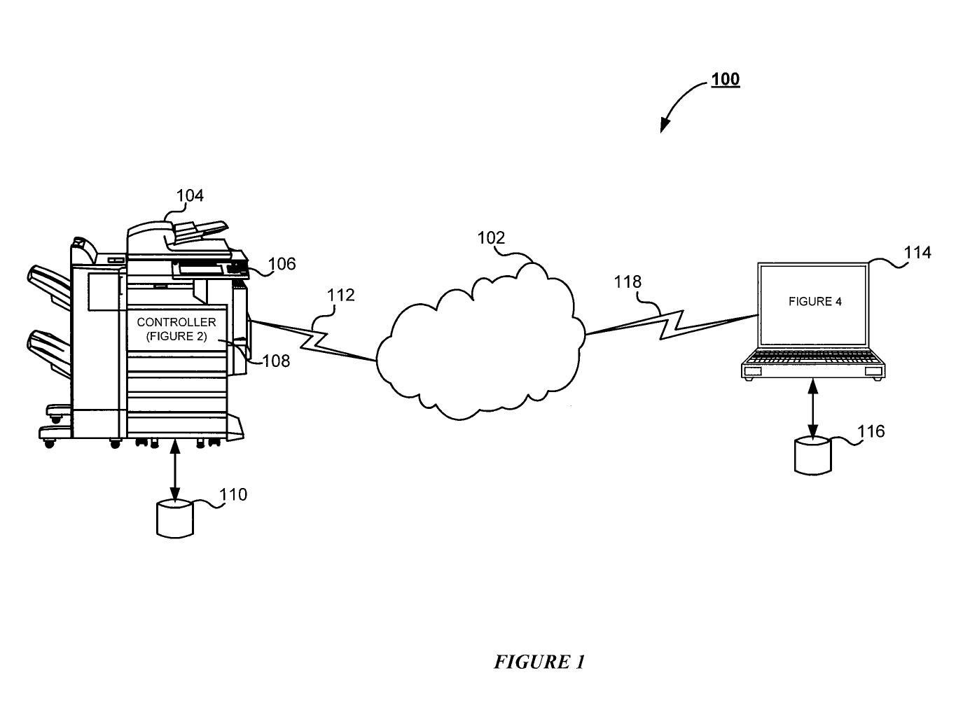

The subject application is directed to a system and method for manipulation of document data intercepted through port redirection. In particular, the subject application is directed to a system and method for rendering of electronically stored documents. More particularly, the subject application is directed to a system and method that allows a user to assembly and rendering of electronically stored documents intercepted from one or more virtual output ports associated with software applications. It will become apparent to those skilled in the art that the system and method described herein are suitably adapted to a plurality of varying electronic fields employing image processing, including, for example and without limitation, communications, general computing, data processing, document processing, document output, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for manipulation of image data intercepted through port redirection in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document rendering device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering device 104 is suitably adapted to provide document processing services to external or network devices. Preferably, the document rendering device 104 includes hardware, software, and any suitable combination thereof, configured to interact with an associated user, a networked device, or the like.

According to one embodiment of the subject application, the document rendering device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document rendering device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

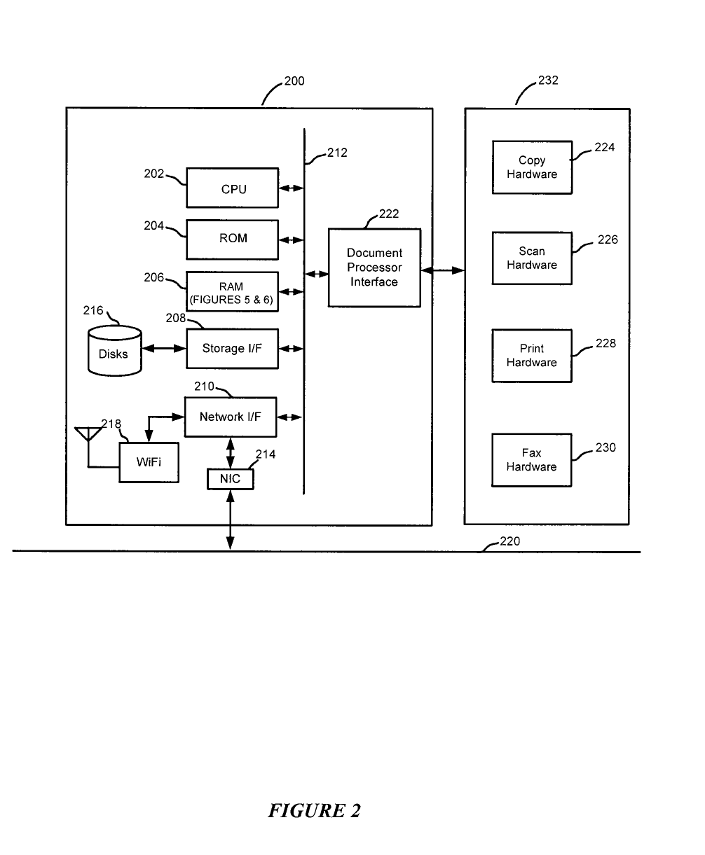

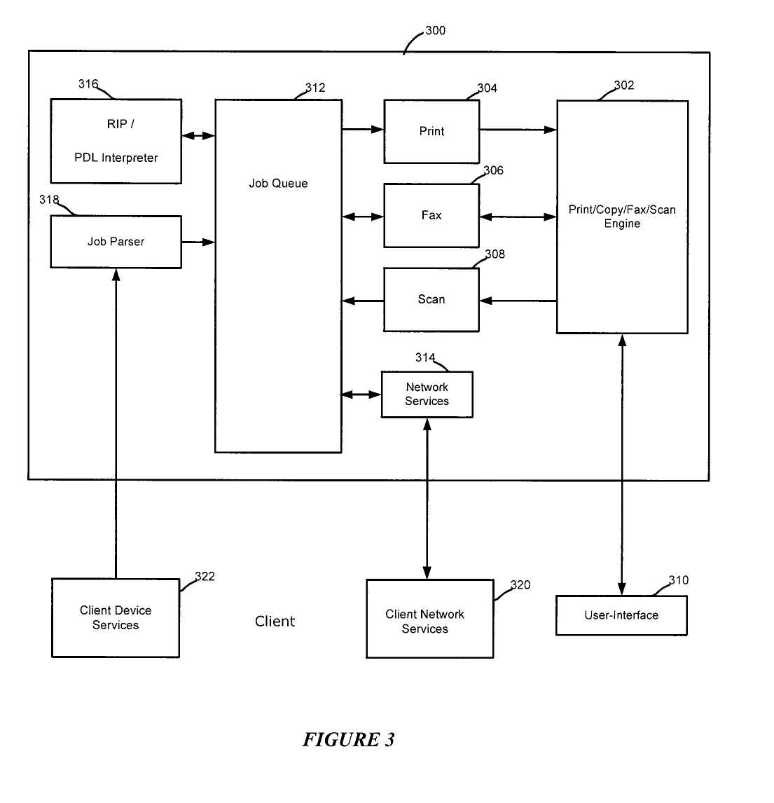

In accordance with one embodiment of the subject application, the document rendering device 104 further incorporates a backend component, designated as the controller 108, suitably adapted to facilitate the operations of the document rendering device 104, as will be understood by those skilled in the art. Preferably, the controller 108 is embodied as hardware, software, or any suitable combination thereof, configured to control the operations of the associated document rendering device 104, facilitate the display of images via the user interface 106, direct the manipulation of electronic image data, and the like. For purposes of explanation, the controller 108 is used to refer to any myriad of components associated with the document rendering device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for manipulation of document data intercepted through port redirection of the subject application. The functioning of the controller 108 will better be understood in conjunction with the block diagrams illustrated in FIGS. 2 and 3, explained in greater detail below.

Communicatively coupled to the document rendering device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document rendering device 104, a component of the controller 108, or the like, such as, for example and without limitation, an internal hard disk drive, or the like.

The system 100 illustrated in FIG. 1 further depicts a user device 114, in data communication with the computer network 102 via a communications link 118. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 118 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102. The user device 114 of the subject application also includes a port redirector component, various software drivers, applications, and the like, as will be explained in greater detail below.

In accordance with one embodiment of the subject application, the user device 114 includes an associated memory, illustrated in FIG. 1 as the data storage device 116. It will be appreciated by those skilled in the art that the data storage device 116 is any mass storage device known in the art including, for example and without limitation, magnetic storage drives, a hard disk drive, optical storage devices, flash memory devices, or any suitable combination thereof. According to one particular embodiment of the subject application, the data storage device 116 is suitably adapted to store output data, document data, image data, electronic database data, or the like. It will be appreciated by those skilled in the art that while illustrated in FIG. 1 as being a separate component of the system 100, the data storage device 116 is capable of being implemented as internal storage component of the user device 114, such as, for example and without limitation, an internal hard disk drive, or the like. As will be addressed below, the data storage device 116 is capable of storing output data corresponding to data received by a virtual port, e.g., the port redirector, and thereby allow manipulation thereof by an associated user.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

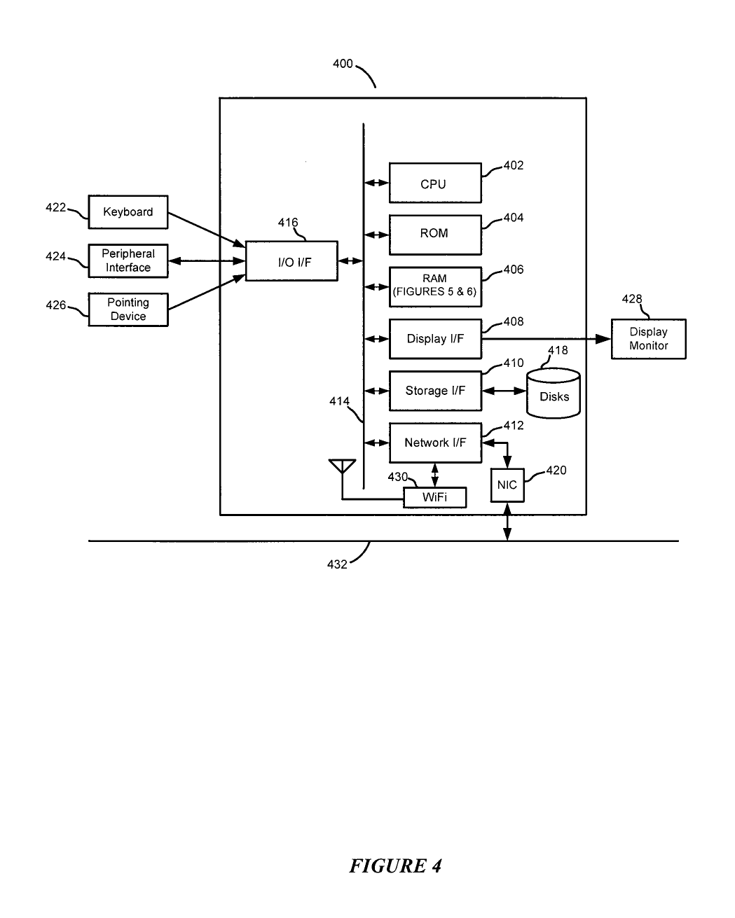

Turning now to FIG. 4, illustrated is a hardware diagram of a suitable workstation 400, illustrated in FIG. 1 as the user device 114, for use in connection with the subject system. A suitable workstation 400 includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, output data targeted to a virtual port is received from each of a plurality of applications, with the virtual port being associated with each application. The output data received at the virtual port is then stored. A display representing the document images associated with the stored output data is then generated. Instructions are then received relative to the manipulation of stored output data according to the generated display. Thereafter, a single output job is output to at least one document rendering device comprising at least a portion of the stored output data.

In accordance with one example embodiment of the subject application, a software component, referred to hereinafter as a port redirector, is initiated on the user device 114. Preferably, the port redirector corresponds to the generation of a virtual port, which is capable of intercepting or receiving output data for output to an associated document rendering device 104. The skilled artisan will appreciate that the port redirector is any hardware, software, or suitable combination thereof, capable of performing the functions described hereinafter. The port redirector then receives output data, e.g., data sent to the virtual port, from a plurality of applications resident on the user device 114, corresponding to electronic documents to be output to an associated document rendering device 104.

According to one embodiment of the subject application, the output data is sent to the virtual port by software drivers associated with each application, as will be understood by those skilled in the art. In such an embodiment, the skilled artisan will appreciate that the software driver is capable of being directed to commence a document processing operation, such as printing, facsimile, electronic mail, storage, or the like. That is, the software driver is directed, by the user via the corresponding application, to commence a document processing operation, whereupon the software driver prepares the document associated with the application in accordance with the selected operation prior to the output thereof to the virtual port. Thus, the skilled artisan will appreciate that the output data received from the software driver is capable of comprising post-raster image processing graphical image data, or the like. The port redirector then stores, via the data storage device 116 associated with the user device 114, the output data in a known location, e.g., a set storage location on the data storage device 116.

Upon receipt of the output data, the port redirector initiates a graphical user interface via the user device 114, which displays document images corresponding to the stored output data. That is, a graphical user interface component associated with the user device 114 is initiated so as to generate a user interface displaying the documents of the received output data, user prompts, and the like. The skilled artisan will appreciate that the prompt corresponds to textual, graphical, auditory, or the like, indicia on the user device 114. In accordance with one embodiment of the subject application, the user is prompted via the graphical user interface to provide modification instructions, or to manipulate the display to reflect a desired output format, order, and other preferences, as will be understood by those skilled in the art. According to another embodiment of the subject application, the graphical user interface is generated via an associated thin client. For example, the port redirector and corresponding applications are accessed via an associated thin client, such as a web browser over the computer network 102.

The user instructions relative to the manipulation of the output data are then received via the graphical user interface associated with the port redirector. In accordance with one example embodiment of the subject application, the user instructions are received via a graphical display generated on an associated thin client, e.g., a web browser, the user interface 106, or the like. Thereafter, a suitable component associated with the user device 114, e.g., the port redirector, a driver, or other suitable hardware/software, performs the instructions resulting in manipulated output data. The manipulated output data is then communicated to a suitable spooler, as will be understood in the art. At least a portion of the manipulated output data is then communicated to the associated document rendering device 104 via the computer network 102, as a single document processing job.

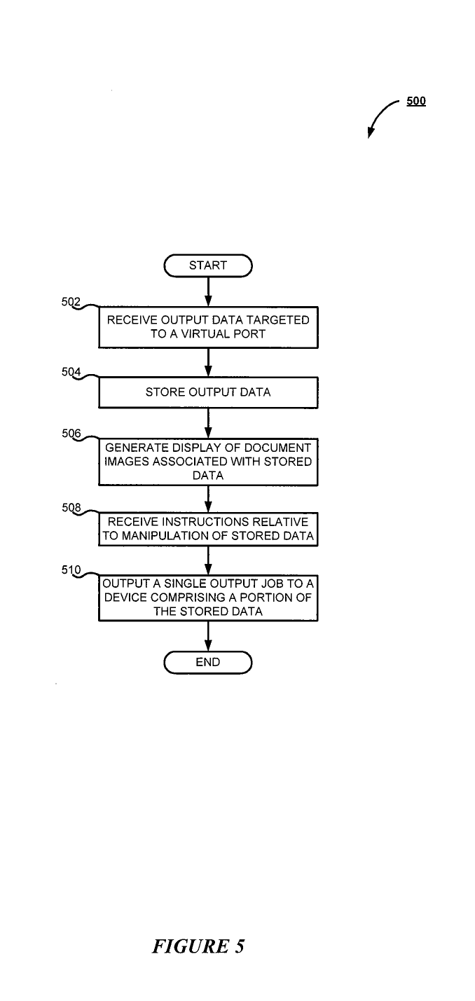

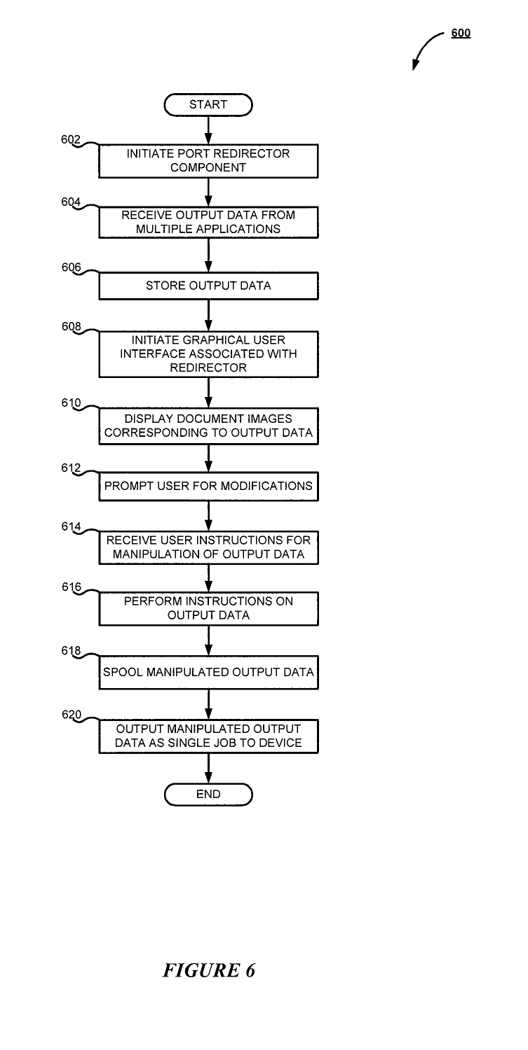

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for manipulation of image data intercepted through port redirection in accordance with one embodiment of the subject application. Beginning at step 502, a virtual port, e.g., a port redirector component, resident on the user device 114 receives output data targeted to the port by one or more applications of the user device 114. In accordance with one embodiment of the subject application, a port redirector is operative on the user device 114, which facilitates the interception of output requests from applications of the user device 114. Preferably, the port redirector establishes a virtual port on the user device 114 to which applications are capable of outputting data. The skilled artisan will appreciate that the one or more applications includes one or more corresponding software drivers, or other suitable components of software, configured to facilitate the output of data from its associated application. For example, the skilled artisan will appreciate that a word processing application will have a corresponding software driver for outputting a document associated therewith, as will an image processing application have an associated driver for outputting an image corresponding thereto. In accordance with one embodiment of the subject application, the WINDOWS operating system-based “GetPrinter” function, by way of virtual port creation, is used to retrieve information about the specified printer that the port redirector is emulating. The data structure that contains the information that printer is then copied. The printer name is then changed to a new name and the Port Name is specified to the new Print Redirector Port.

The user device 114, in association with the virtual port, then stores the output data in an associated data storage device 116, at step 504. Preferably, the storage location, e.g., the data storage device 116, includes a dedicated storage area for storage of output data targeted to the virtual port by the applications, e.g., the software drivers, of the user device 114. At step 506, a display is generated of document images associated with the stored output data on the user device 114. Instructions relative to the manipulation of the stored output data is then received from an associated user at step 508 via the user device 114. Thereafter, at step 510, a single output job is output to the document rendering device 104 corresponding to at least a portion of the stored output data.

Referring now to FIG. 6, there is shown a flowchart 600 illustrating a method for manipulation of image data intercepted through port redirection in accordance with one embodiment of the subject application. The method depicted in FIG. 6 begins at step 602, whereupon a port redirector component is initiated on an associated user device 114. It will be appreciated by those skilled in the art that the port redirector is any software, hardware, or suitable combination thereof capable of facilitating the receipt and interception of output data from one or more applications resident on the user device 114. In accordance with one embodiment of the subject application, the port redirector establishes a virtual port associated with each such software application. Preferably, a suitable software driver associated with each application facilitates the communication of output from the application to the virtual port, as will be understood by those skilled in the art.

At step 604, the virtual port, e.g., the port redirector component, receives output data from multiple applications corresponding to electronic documents, images, files, and the like. Preferably, the output data is received from a software driver, as will be understood by those skilled in the art, associated with the corresponding software application. The skilled artisan will appreciate that the software driver is capable of being directed to commence a document processing operation, such as printing, facsimile, electronic mail, storage, or the like, by a user via the associated application. Thus, the software driver prepares the document associated with the application in accordance with the selected operation prior to the communication of the output data to the virtual port. In accordance with one embodiment of the subject application, the output data received from the software driver comprises post-raster image processing graphical image data, or the like. For example, a user associated with the user device 114 selects a word processing document, a spreadsheet document, and an image document, each from within separate applications, and selects the virtual port as the output destination, e.g., print to the virtual port. The virtual port receives these files, or output data, at step 604.

The received output data is then stored, at step 606, in a suitable storage location, e.g., data storage device 116, associated with the user device 114. At step 608, the port redirector initiates a graphical user interface application on the user device 114 to facilitate further input by the user of processing instructions. In accordance with one embodiment of the subject application, a custom application is launched on the user device 114 associated with the receipt of output data at the virtual port. According to another embodiment of the subject application, the graphical user interface is generated via an associated thin client. For example, the port redirector and corresponding applications are accessed via thin client, such as a web browser over the computer network 102.

The user device 114 then displays, at step 610, document images corresponding to the received output data via the graphical user interface application. The user is then prompted, at step 612, to input modifications or other manipulations to the document images via the graphical user interface application of the user device 114. The user device 114 then receives, via the graphical user interface application, instructions from the associated user corresponding to the manipulation of the document images of the output data at step 614. For example, the user is capable of providing instructions associated with the order of the documents, printing preferences, collation preferences, output formats, and the like. In accordance with one example embodiment of the subject application, the user instructions are received via a graphical display generated on an associated thin client, e.g., a web browser, the user interface 106, or the like. At step 616, the user device 114 performs the received instructions on the received output data, so as to generate manipulated output data. The manipulated output data is then communicated, at step 618, to an associated spooler. Those skilled in the art will appreciate that the spooler is any suitable output spooler known in the art including, for example and without limitation, a print spooler. All or a portion of the manipulated output data is then communicated, at step 620, to the document rendering device 104 as a single document processing job.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for manipulation of document data intercepted through port redirection comprising:
a virtual port associated with each of a plurality of applications;
means adapted for receiving output data targeted to the virtual port from each of the plurality of applications;
memory means adapted for storing output data received in the virtual port;
means adapted for generating a display representative of document images associated with stored print data;
interface means adapted for receiving instructions relative to manipulation of stored output data in accordance with a generated display; and
means adapted for outputting, to at least one document rendering device, a single output job comprising at least a portion of stored output data.

2. The system of claim 1 further comprising spooler means adapted for spooling the output job prior to rendering.

3. The system of claim 2 further comprising at least one software driver associated with each of the plurality of applications, and wherein output data is received into the virtual port therefrom.

4. The system of claim 3 wherein the document rendering device includes a multifunction peripheral, and wherein the at least one software driver is directed to commence at least one operation chosen from the set of printing, facsimile transmission, and electronic mail transmission.

5. The system of claim 4 wherein the output data includes graphical image data.

6. The system of claim 5 wherein the output data is further comprised of post-raster image processing graphical image data.

7. The system of claim 6 wherein the interface means includes a graphical display generated on an associated thin client.

8. A method for manipulation of document data intercepted through port redirection comprising the steps of:
receiving output data targeted to a virtual port from each of a plurality of applications, wherein the virtual port is associated with each of the plurality of applications;
storing output data received in the virtual port;
generating a display representative of document images associated with stored output data;
receiving instructions relative to manipulation of stored output data in accordance with a generated display; and
outputting, to at least one document rendering device, a single output job comprising at least a portion of stored output data.

9. The method of claim 8 further comprising the step of spooling the output job prior to rendering.

10. The method of claim 9 further comprising the step of receiving output data from at least one software driver associated with each of the plurality of applications into the virtual port.

11. The method of claim 10 wherein the document rendering device includes a multifunction peripheral, and further comprising the step of directing the software driver to commence at least one operation chosen from the set of printing, facsimile transmission, and electronic mail transmission.

12. The method of claim 11 wherein the output data includes graphical image data.

13. The method of claim 12 wherein the output data is further comprised of post-raster image processing graphical image data.

14. The method of claim 13 wherein the step of receiving instructions relative to manipulation of stored print data is via a graphical display generated on an associated thin client.

15. A computer-implemented method for manipulation of document data intercepted through port redirection comprising the steps of:
receiving output data targeted to a virtual port from each of a plurality of applications, wherein the virtual port is associated with each of the plurality of applications;
storing output data received in the virtual port;
generating a display representative of document images associated with stored output data;
receiving instructions relative to manipulation of stored output data in accordance with a generated display; and
outputting, to at least one document rendering device, a single output job comprising at least a portion of stored output data.

16. The computer-implemented method of claim 15 further comprising the step of spooling the output job prior to rendering.

17. The computer-implemented method of claim 16 further comprising the step of receiving output data from at least one software driver associated with each of the plurality of applications into the virtual port.

18. The computer-implemented method of claim 17 wherein the document rendering device includes a multifunction peripheral, and further comprising the step of directing the software driver to commence at least one operation chosen from the set of printing, facsimile transmission, and electronic mail transmission.

19. The computer-implemented method of claim 11 wherein the output data includes graphical image data.

20. The computer-implemented method of claim 19 wherein the step of receiving instructions relative to manipulation of stored print data is via a graphical display generated on an associated thin client.
